(19) United States
(12) Patent Application Publication
(10) Pub. No.: US 2026/0330053 A1
(43) Pub. Date: Oct. 22, 2026

(54) NOISE PARAMETER SETTING FOR DISTANCE PRESERVING ENCRYPTION

(71) Applicant: International Business Machines Corporation, Armonk, NY (US)

(72) Inventors: Charanjit Singh Jutla, New York, NY (US); Sikhar Patranabis, Bangalore (IN); Nathan J Manohar, White Plains, NY (US); Dhilung Hang Kirat, Hartsdale, NY (US)

(73) Assignee: International Business Machines Corporation, Armonk, NY (US)

(21) Appl. No.: 19/180,780

(22) Filed: Apr. 16, 2025

(51) Int. Cl. G06F 21/62; G06F 21/60

(52) U.S. Cl. CPC G06F 21/6227; G06F 21/602

(57) ABSTRACT

An embodiment compares to a threshold a first dataset characteristic of a set of embedding vectors generated from a set of natural language documents. The embodiment appends a first amount of text data to the natural language documents outputting a first set of augmented documents according to a noise parameter based on the first comparison result. The embodiment generates a first set of modified vector embeddings representing the first set of augmented documents. The embodiment iteratively adjusts the noise parameter, wherein each iteration changes the first amount of text data according to a comparison in the successive comparisons, and outputs an adjusted noise parameter for the iteration. The embodiment augments the first portion of the natural language documents by appending a changed amount text data in accordance with the adjusted noise parameter to generate a changed set of augmented documents. The embodiment outputs a final set of modified vector embeddings.

### BACKGROUND

The present invention relates generally to cryptographic encryption. More particularly, the present invention relates to a method, system, and computer program providing noise parameter setting for distance preserving encryption.

Cryptography is the practice of securing communication and information from potential adversaries. Encrypting data provides confidentiality, integrity, authentication, and non-repudiation to data. Cryptography involves various methods for encrypting as well as decrypting data. Encryption is the process of converting plaintext into ciphertext whereas decryption is the process of converting cyphertext back into readable plaintext. A system may employ cryptographic algorithms to convert plaintext into ciphertext, and vice versa. Cryptography is utilized in various aspects throughout cybersecurity, and may be leveraged in various domains, including protecting private communications to securing information stored on cloud databases.

Distance preserving encryption (DPE) is a cryptographic technique that aims to maintain the relationships and distances between data points in the original data space (plaintext) once the data has become encrypted and stored in the encrypted data space (ciphertext). This encryption method aims to preserve the geometric structure and proximity of data points during the encryption process, such that the relative distances between data points remain consistent before and after encryption. By maintaining the spatial relationships and distances within the data, distance preserving encryption allows for secure data transmission and storage while preserving the usefulness of similarities and other relationships between the store data.

Entropy is a measure of uncertainty or randomness in a system. Probability distributions describe the likelihood of different outcomes or events occurring within a given system. Entropy is calculated based on the probabilities assigned to different outcomes in a probability distribution. Accordingly, entropy provides a quantitative measure of the uncertainty or information content present in a probability distribution. Higher entropy values indicate greater uncertainty and randomness in the distribution, while lower entropy values suggest more predictability and structure.

### SUMMARY

The illustrative embodiments provide for setting an adjustable noise parameter for distance preserving encryption.

An embodiment includes comparing to a threshold a first dataset characteristic of a set of embedding vectors generated from a set of natural language documents, the comparing producing a first comparison result. The embodiment also includes appending to output a first set of augmented documents, by executing a first specifically purposed code within a noise generating module of an encryption manager application, a first amount of text data to a first portion of a natural language document from the set of natural language documents according to a noise parameter based on the first comparison result. The embodiment also includes generating, by processing the first set of augmented documents through a large language model, a first set of modified vector embeddings representing the first set of augmented documents. The embodiment also includes adjusting, by iteratively executing a second specifically purposed code within the noise generating module, the noise parameter based on successive comparisons between an updated dataset characteristic and the threshold, wherein in an iteration the second specifically purposed code changes the first amount of text data according to a comparison in the successive comparisons, and outputs an adjusted noise parameter for the iteration. The embodiment also includes augmenting the first portion of the natural language documents by appending a changed amount text data in accordance with the adjusted noise parameter to generate a changed set of augmented documents. The embodiment also includes outputting, by executing a third specifically purposed code within the noise module of the encryption manager application, a final set of modified vector embeddings corresponding to the set of natural language documents, the final set of modified vector embeddings being usable to tune a distance preserving setting in an encryption operation.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module in accordance with an illustrative embodiment;

FIG. 4 depicts a block diagram of an example database management system in accordance with an illustrative embodiment;

FIG. 5 depicts a block diagram of a vector embedding space in accordance with an illustrative embodiment;

FIG. 6 depicts a flowchart of an example encryption process in accordance with an illustrative embodiment; and

FIG. 7 depicts a flowchart of an example encryption process in accordance with an illustrative embodiment.

### DETAILED DESCRIPTION

Encryption is a process of converting plaintext data into ciphertext using cryptographic algorithms and keys to protect the confidentiality and integrity of the information. In encryption, the original data is transformed into an encrypted format that can only be deciphered back into its original form by authorized parties with the corresponding decryption key.

Encrypting a vector embedding database involves applying encryption techniques to secure the vector representations of words, phrases, or documents stored in the database. By encrypting the vector embeddings, sensitive semantic information encoded in the vectors is protected from unauthorized access or disclosure. This process aims to provide added security for information stored on a database, since even if the database is compromised, the encrypted vector embeddings remain secure and confidential, safeguarding the underlying data and preserving the privacy of the information.

Large Language Models (LLMs) process vector embeddings by leveraging various natural language processing techniques to encode textual data into high-dimensional vector representations that capture the semantic and contextual information of the text. LLMs, such as transformer-based models like BERT (Bidirectional Encoder Representations from Transformers) or GPT (Generative Pre-trained Transformer), provide for generating dense vector embeddings that capture the meaning and relationships between words, phrases, and sentences.

The distance between vector embeddings refers to the measure of separation or similarity between two vector representations in a high-dimensional space. The distance between vector embeddings is typically calculated using metrics such as Euclidean distance, cosine similarity, or other distance measures, which quantify the similarity or dissimilarity between the vectors. Closer vector embeddings indicate a higher degree of similarity or relatedness between the entities they represent, while farther vector embeddings suggest greater dissimilarity or distinction between the entities. Preserving the distances between vector embeddings ensures that the semantic relationships and contextual information encoded in the vectors are maintained, allowing for secure encryption and decryption processes without compromising the meaningful structure of the data.

Distance preserving encryption provides security while ensuring that the relationships and distances between vector embeddings are maintained during the encryption process, thereby protecting the integrity and confidentiality of the data while preserving the essential structural properties of the information. In distance preserving encryption, the goal is to encode the vector embeddings in such a way that the distances between data points in the original vector space are preserved in the encrypted space. This means that similar data points remain close to each other in the encrypted space, while dissimilar data points are kept at a distance from each other. By maintaining these distance relationships, distance preserving encryption allows for encrypted searching a database.

An adversary may employ an iterative query-based attack strategy to attempt to decrypt encrypted vector embeddings by leveraging the query results obtained from the system. This type of attack involves sending a series of queries to the system and analyzing the responses or query results to gather information that can be used to infer details about the encrypted data and potentially decrypt it. Initially, the adversary may transmit a set of queries to the system, requesting specific information or data based on the encrypted vector embeddings. By analyzing the responses or query results received from the system, the adversary can gain insights into the structure, patterns, or relationships within the encrypted data. The query results may provide clues or hints about the underlying data, allowing the adversary to make educated guesses or inferences about the encrypted vector embeddings.

Based on the information obtained from the query results, the adversary may iteratively refine their queries and adjust their approach to extract more details about the encrypted data. Through a series of iterative queries and analysis of the query results, the adversary aims to exploit any patterns, correlations, or information leakage present in the system's responses to decrypt the encrypted vector embeddings. By strategically probing the system and leveraging the query results to gather intelligence about the encrypted data, the adversary attempts to uncover the encryption keys, parameters, or decryption mechanisms used in the encryption process.

Despite improved capabilities of encryption technologies and schemes, the existing distance-preserving encryption techniques are nevertheless still susceptible to incremental-based attacks from an adversary. Incremental-based attacks can undermine the security of the encryption scheme due to the inherent vulnerabilities in the encryption scheme that can be exploited to compromise the security of the system.

One vulnerability arises from the incremental nature of the isomorphic transformation, where small changes in the input data result in corresponding incremental changes in the output data. Adversaries can leverage this property to launch incremental-based attacks by making subtle modifications to the input data and observing the resulting changes in the encrypted output. By iteratively adjusting the input data and analyzing the incremental changes in the encrypted vectors, adversaries can potentially infer sensitive information or reverse-engineer the encryption process to recover the original data. Small variations or perturbations in the input data can lead to significant changes in the encrypted vectors, allowing adversaries to manipulate the input data strategically to reveal patterns or relationships in the encrypted space. This vulnerability can be exploited to breach the security of the system and compromise the confidentiality of the data.

The present disclosure addresses the deficiencies described above by providing a process (as well as a system, method, machine-readable medium, etc.) that develops a distance preserving encryption that includes customizable noise parameter setting. Disclosed embodiments leverage capabilities of a large language models generating vector embeddings and distance preserving encryption techniques to safeguard high entropy data stored on an encrypted vector database. The illustrative embodiments provide a distance-comparison-preserving encryption scheme for encrypting natural language embedding vectors. Embodiments enable encrypted search on embedding vectors stored in database while preserving privacy and security against adversarial attacks.

As used throughout the present disclosure, the term “distance preserving” refers to a property of an encryption scheme where the relationships and distances between data points in the original data set (plaintext space) are preserved in the encrypted data set (ciphertext space). Accordingly, if two data points are close to each other in the plaintext space, their corresponding encrypted data points are also close to each other in the ciphertext space when their distance is preserved. The distance between data points is measure of separation or similarity between two data points in a dataset. Distance can be calculated using metrics such as Euclidean distance, Manhattan distance, or cosine similarity, depending on the of the data or implementation.

As used throughout the present disclosure, the term “entropy” refers to a measure of the average level of uncertainty or information associated with a variable's potential states or possible outcomes. Entropy measures the expected amount of information needed to describe the state of the variable, considering the distribution of probabilities across all potential states. High entropy information is data with greater unpredictability, where each outcome carries more information because the uncertainty is higher. Undisclosed information has high entropy compared to publicly known information because its content may be less predictable and more uniformly distributed from the perspective of an external observer (such as an attacker or a large language model trying to infer stored data). Accordingly, undisclosed information may be considered high entropy since it is initially unpredictable, whereas publicly known data is low entropy because it is more likely to follow common patterns.

As used throughout the present disclosure, the term “noise parameter” refers to a variable used in data processing and encryption algorithms to introduce randomness or perturbations to the data. In an embodiment, the noise parameter controls the level of distortion or variability added to the data. Further, adjusting the noise parameter allows for the customization of the amount and type of noise introduced to the data, thereby influencing the quality, integrity, and confidentiality of the processed information.

As used throughout the present disclosure, the term “vector embedding” (or simply “embedding”) refers to a digital representation of an object in a multi-dimensional space. An embedding translates complex data (e.g., words, images, etc.) into a vector form that a machine learning model can process. The Euclidean distance or cosine similarity may be used to measure how similar two vectors are. Similar items have vectors that are close together, while dissimilar vectors are farther apart. Vector embeddings are used in various tasks such as clustering, similarity search, and classification.

As used throughout the present disclosure, the term “vector embedding space” refers to a high-dimensional digital space where words, phrases, documents, etc. are represented as vectors with semantic meaning encoded in their geometric relationships. Each entity may be mapped to a vector such that similar entities are located close to each other, capturing semantic similarities and relationships between them. The vector embedding spaces may be generated using word embeddings or document embeddings, where words or documents are transformed into continuous vector representations based on their contextual usage or content. Transforming a database into a vector embedding space improves tasks related to natural language processing, information retrieval, and machine learning by causing information stored on the database to capture the semantic relationships between entities in a structured and meaningful way.

Illustrative embodiments include a method providing an adjustable noise distance-preserving encryption. An embodiment includes tuning a noise parameter based on the characteristics of the data stored on a database. By examining the distribution of data points, the range of values, and/or the relationships between vectors, the appropriate level of noise can be determined to preserve the distances between data points during encryption.

In an embodiment, the noise parameter may be tuned based on a known probability distribution from which the vector-database is sampled or a reference dataset. By leveraging a probability distribution that represents the underlying data generation process, the noise parameter can be adjusted to align with the expected distribution of the data. By tuning the noise parameter based on either the characteristics of the vector-database or a known probability distribution, the distance-preserving encryption method can effectively balance the security and privacy requirements of the data with the need to maintain the structural relationships and distances between data points.

In an embodiment, the tuning of said noise-parameters may be based on clustering techniques applied to the said vector-database or the said probability distribution. An embodiment includes leveraging a clustering algorithm to analyze the structure and patterns within the data and guide the adjustment of noise levels for distance-preserving encryption. For example, clustering techniques, such as K-means clustering, hierarchical clustering, or DBSCAN, may be utilized to group similar data points together based on their characteristics or proximity in the vector-database. By partitioning the data into clusters, these techniques help identify natural groupings or clusters of data points that share common features or properties.

In an embodiment, a clustering technique can be applied to the vector-database to identify clusters of data points that are desired to be preserved or maintained during the encryption process. By analyzing the clusters and their spatial relationships, the appropriate level of noise can be determined to protect the integrity of these clusters while adding randomness to enhance security. Accordingly, by incorporating clustering techniques into the tuning of noise parameters, the distance-preserving encryption method can adaptively adjust the level of noise based on the inherent structure and relationships within the data and enables preserving important data clusters while introducing controlled randomness to protect sensitive information.

In an embodiment, a clustering technique can be applied to the known probability distribution from which the vector-database is sampled. By clustering data points based on their distribution characteristics, the noise parameter can be adjusted to align with the clusters identified in the probability distribution. This approach causes the noise introduced during encryption to be consistent with the underlying structure and patterns of the data generation process, thereby maintaining the fidelity of the encryption scheme. By incorporating clustering techniques into the tuning of noise parameters, the distance-preserving encryption method can adaptively adjust the level of noise based on the inherent structure and relationships within the data and enables preserving important data clusters while introducing controlled randomness to protect sensitive information.

An embodiment includes a method for adding noise to embedding-vectors so as to enable a distance-preserving encryption. In an embodiment, the noise is added by appending or pre-pending a fresh random piece of text to each document before sending the document through a large-language model transformer to obtain the embedding vector. Accordingly, the process of adding noise through the appending or pre-pending of random text serves to obfuscate the original data while preserving the distance relationships between data points, facilitating secure transmission and storage of sensitive information.

In an embodiment, the noise is added to most components of the embedding vector, but a few selected components, e.g. four components, are left unaltered by noise. These unaltered components may then serve as nonce or seed to which a secret-key pseudorandom-number generator may be applied to obtain the random noise to be added to all the other components. This way, the encrypted embedding vector can be decrypted using the same secret-key. In an embodiment, the four special components can also be chosen secretly. In some embodiments, the number of such special components can be as large as sixteen. The exact number of special components may be implementation specific.

In an embodiment, the embedding vectors are obtained by processing the augmented data, which includes the original document along with the appended or pre-pended random text, through a large-language model transformer. The transformer leverages a natural language processing technique to encode the input data into high-dimensional embedding vectors that capture the semantic and contextual information of the text. By adding noise through the inclusion of random text before generating embedding vectors, the method ensures that the original data is protected from unauthorized access or inference while preserving the distances between data points in the embedding space.

In an embodiment, a process includes comparing to a threshold a first dataset characteristic of a set of embedding vectors generated from a set of natural language documents, the comparing producing a first comparison result. The embodiment also includes appending to output a first set of augmented documents, by executing a first specifically purposed code within a noise generating module of an encryption manager application, a first amount of text data to a first portion of a natural language document from the set of natural language documents according to a noise parameter based on the first comparison result. The embodiment also includes generating, by processing the first set of augmented documents through a large language model, a first set of modified vector embeddings representing the first set of augmented documents. The embodiment also includes adjusting, by iteratively executing a second specifically purposed code within the noise generating module, the noise parameter based on successive comparisons between an updated dataset characteristic and the threshold, wherein in an iteration the second specifically purposed code changes the first amount of text data according to a comparison in the successive comparisons, and outputs an adjusted noise parameter for the iteration. The embodiment also includes augmenting the first portion of the natural language documents by appending a changed amount text data in accordance with the adjusted noise parameter to generate a changed set of augmented documents. The embodiment also includes outputting, by executing a third specifically purposed code within the noise module of the encryption manager application, a final set of modified vector embeddings corresponding to the set of natural language documents, the final set of modified vector embeddings being usable to tune a distance preserving setting in an encryption operation.

In an embodiment, the above process further includes encrypting, by executing a fourth specifically purposed code within an encryption module of the encryption manager application, and by using the distance preserving setting in a distance preserving scheme technique, the final set of modified vector embeddings. In an embodiment, the encrypting uses a distance-preserving encryption function, wherein the final set of modified vector embeddings is responsive to an n-th comparison in an n-th iteration indicating a less than a preset amount of benefit by further changing a previous amount of text data from the (n-1)th iteration.

In an embodiment, the above process further includes measuring, within a measurement module of the encryption manager application, the first dataset characteristic from a set of embedding vectors generated from the set of natural language documents.

In an embodiment, the above process further includes initializing the noise parameter based on the first comparison result, wherein the first amount of text data is selected based on the first comparison result.

In an embodiment, the above process further includes generating, during the iteratively executing the second specifically purposed code, successive sets of modified vector embeddings from successive sets of augmented documents by processing each iteratively augmented documents through the large language model, a modified vector embedding in the successive sets of modified vector embeddings representing a corresponding augmented document.

In an embodiment of the above process, the adjusting, the augmenting, and the generating are repeated until an n-th comparison in an n-th iteration indicating a less than a preset amount of benefit by further changing a previous amount of text data from the (n−1)th iteration. In an embodiment of the above process, the changed amount text data is an additional amount of text data.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

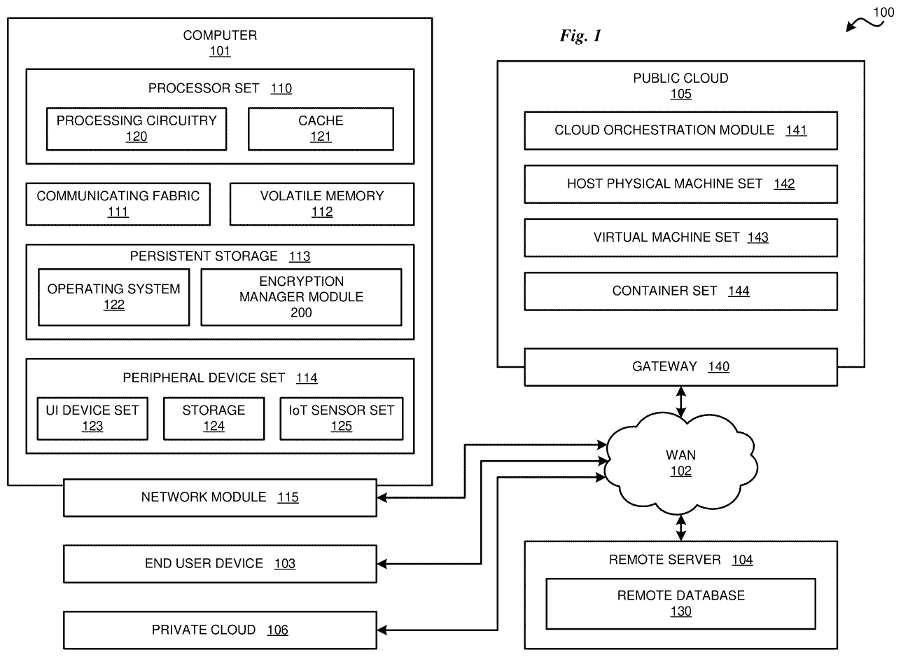

FIG. 1 depicts a block diagram of a computing environment 100. Computing environment 100 contains an example of an environment for the execution of at least some of the computer code involved in performing the inventive methods, such as encryption manager module 200 that provides automated threat investigation. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

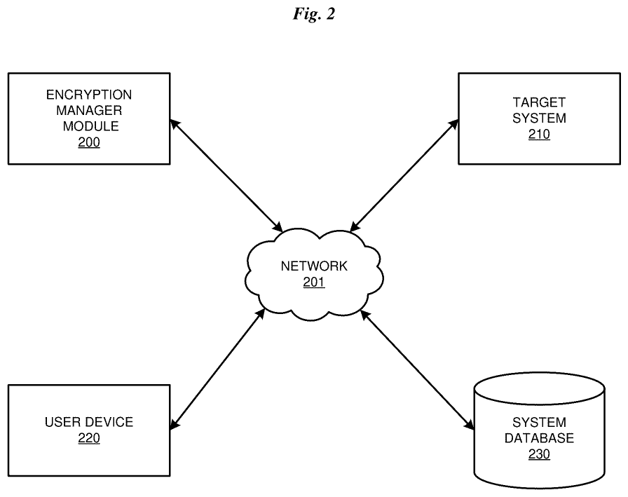

FIG. 2 depicts a block diagram of an example computing environment in accordance with an illustrative embodiment. In the illustrated embodiment, the encryption manager module 200 includes the encryption manager module 200 of FIG. 1. In the illustrated embodiment, the encryption manager module 200 is configured to encrypt data stored on system database 230. In an embodiment, the encryption manager module 200 is configured to encrypt high-entropy data stored on system database 230 given a probability distribution corresponding to vector embeddings representative of data stored on system database 230. In an embodiment, the encryption manager module 200 serves as a central component responsible for managing the encryption and decryption processes within the system. The encryption manager module 200 interacts with various system components described herein to ensure secure data transmission and storage.

In an embodiment, the network 201 serves as a communication infrastructure that facilitates data exchange between different system entities, including the encryption manager module 200, the target system 210, the system database 230, and the user device 220. The network 201 enables the transmission of encrypted data between these and other components.

In an embodiment, the target system 210 includes a computer system corresponding to an intended recipient or destination system where the encrypted data is transmitted for processing or storage. The encryption manager module 200 encrypts the data before sending the data to the target system 210 via the network 201 to protect the information during transit and stored.

In an embodiment, the system database 230 serves as the repository for storing and managing data related to target system 210. The encryption manager module 200 interacts with the system database 230 to encrypt sensitive information before storing it securely. Encrypted data is retrieved from the system database 230 and decrypted by the encryption manager module 200 when needed for processing or retrieval. In an embodiment, the user device 220 includes an endpoint device used by a user to interact with the target system 210.

In an embodiment, the encryption manager module 200 includes a key generation component, an encryption component, and a decryption component. In an embodiment, the key generation component is responsible for generating encryption and decryption keys using one or more cryptographic algorithms. In an embodiment, the encryption component provides a distance preserving encryption function. In an embodiment, the encryption component takes the plaintext data and the encryption key as input and transforms the data into ciphertext using encryption algorithms and the decryption component takes the ciphertext and the decryption key as input and reverses the encryption process to recover the original plaintext data.

In an embodiment, the encryption manager module 200 is configured to maintain the distance between data points in both the plaintext space and the ciphertext space. By maintaining the distance between data points remains before and after encryption, the distance preserving encryption method allows for secure data transmission and storage while still providing context-based processing on the vector embeddings based on distances between vector embeddings. In an embodiment, the encryption manager module 200 leverages entropy as a measure to determine which information in a database needs to be encrypted, with a focus on protecting highly confidential data that is less predictable due to its uniqueness, complexity, and/or limited public disclosure.

In an embodiment, the encryption manager module 200 is aimed towards enhancing the security and privacy of the distance-preserving encryption scheme by increasing the difficulty to compute a sentence of k-keywords that map closely to a document in the database 230. In an embodiment, the parameter k represents the number of keywords in the sentence. By increasing the difficulty to find a k-keyword sentence that closely matches a document's embedding vector, the encryption manager module 200 improves the distance reversing encryption scheme and strengthens data confidentiality.

In an embodiment, the choice of the parameter k can be based on the characteristics of the dataset or its distribution, thereby providing a customizable approach to setting the value. Selecting an appropriate value for k involves considering the tradeoff between privacy preservation and decryption time, as a larger k may offer increased security but could lead to longer decryption processes. Embodiments disclosed herein consider that it is desirable to establish that a k-keyword sentence closely matching a document is not easily obtainable, reinforcing the robustness of the encryption scheme against adversarial attacks.

In an embodiment, if an adversary outputs a k-keyword sentence attempting to match a document's embedding vector, the encryption manager module 200 stipulates that there must exist a (k−1)-keyword sub-sentence that is equally close or closer to the document with high probability. This condition ensures that even if the adversary generates a k-keyword sentence, there will likely be a shorter sub-sentence that is as close or closer to the document, indicating the difficulty of finding an exact match and reinforcing the security of the encryption scheme against unauthorized access and decryption attempts.

In an embodiment, user device 220 may support various communication channels, such as a graphical user interface (GUI), a command-line interface (CLI), a web-based portal, or a mobile application, depending on the system's design and user requirements. Users can communicate with the encryption manager module 200 in real-time, providing instructions for executing functions and setting any parameters described herein.

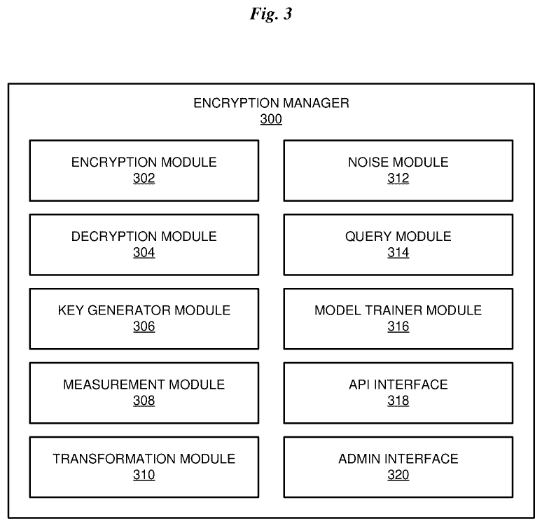

FIG. 3 depicts a block diagram of an example encryption manager 300 in accordance with an illustrative embodiment. In the illustrated embodiment, encryption manager 300 is an example of encryption manager module 200 FIG. 2. In the illustrated embodiment, the encryption manager 300 includes a software module including a plurality of other software modules, including an encryption module 302, a decryption module 304, a key generator module 306, a measurement module 308, a transformation module 310, a noise module 312, a query module 314, a model trainer module 316, API interface 318, and a admin interface 320 In alternative embodiments, encryption manager 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the encryption manager 300 comprises a physical computing device, including but not limited to, a general-purpose computer, a mainframe computer, a supercomputer, a quantum computer, a computer server, a personal computer, a laptop, a smartphone, a tablet, a personal digital assistant (PDA), etc., and any combination thereof. In some embodiments, the encryption manager 300 comprises specialized hardware, such as for example, an Application-Specific Integrated Circuit (ASIC) or Field-Programmable Gate Array (FPGA) for accelerated processing of specific tasks, routines, algorithms, training operations, etc. In some embodiments, the encryption manager 300 may include a combination of physical and virtualized components, as well as may be partially or entirely virtualized on a virtual machine.

In the illustrated embodiment, the encryption module 302 is configured to encrypt plaintext data thereby transforming the plaintext data into ciphertext. In an embodiment, the encryption module 302 transforms the plaintext into ciphertext by applying an isomorphic transformation module within the transformation module 310. In an embodiment, the transformation module 310 prepares the data for encryption by encoding the data into a format that aligns with the encryption scheme's requirements. In the illustrated embodiment, the key generator module 306 generates a secret key that may be utilized to decrypt the ciphertext. In the illustrated embodiment, the decryption module 304 applies the secret key generated by the key generator module 306 to decrypt the ciphertext back into plaintext.

In the illustrated embodiment, the measurement module 308 captures and quantifies the relevant metrics or characteristics of the data. In an embodiment, the measurement module 308 measures various parameters, distances, or features of the data that may be leveraged for the encryption and querying processes.

In the illustrated embodiment, the noise module 312 introduces randomness or perturbations to the data to enhance security and privacy during the encryption process. The noise module 312 adds noise to the data to obfuscate sensitive information and protect it from unauthorized access. In an embodiment, the noise module 312 generates noise for encryption while preserving the relevant relationships and distances between data points. In an embodiment, the noise module 312 generates an initial noise parameter that is applied to the vector embeddings representing data. In an embodiment, the noise module 312 modifies the initial noise parameter based on measurement data obtained by the measurement module 308.

In the illustrated embodiment, the query module 314 facilitates the retrieval and querying of encrypted data, allowing users to search for specific information within the encrypted dataset. The query module 314 enables users to submit queries or requests for data retrieval, which are processed and matched against the encrypted data using secure encryption techniques.

In the illustrated embodiment, the model trainer module 316 is configured to train a large language model, such as a transformer-based model like BERT or GPT, to transform natural language documents into a set of vector embeddings. In an embodiment, the model trainer module 316 initializes the large language model architecture, setting up the neural network structure, layers, and parameters required for training. The architecture is designed to process sequential input data, such as text documents, and generate meaningful vector embeddings that capture the semantic and contextual information of the text. In an embodiment, the model trainer module 316 prepares the training data, which consists of a large corpus of natural language documents. The training data may be preprocessed and tokenized to convert the text into numerical input that can be fed into the model. Tokenization involves breaking down the text into individual tokens or subwords, which are then mapped to corresponding embeddings in the model. In an embodiment, the model trainer module 316 trains the large language model on the prepared training data using techniques such as supervised learning or self-supervised learning. During training, the model learns to encode the input text into dense vector representations by adjusting the weights and parameters of the neural network through backpropagation and optimization algorithms.

As the training progresses, the model trainer module 316 fine-tunes the model's parameters to minimize the loss function and improve the model's ability to generate accurate vector embeddings. The training process involves multiple epochs, where the model iteratively learns from the training data to enhance its language understanding capabilities. Once the training is complete, the model trainer module 316 evaluates the performance of the trained large language model using validation data to assess its ability to transform natural language documents into high-quality vector embeddings. The model trainer module 316 may fine-tune the model further based on the evaluation results to optimize its performance for generating vector representations of text data.

In the illustrated embodiment, the application programming interface module 318 serves as the interface through which users and/or applications interact with the encryption manager 300 and facilitates the exchange of information between the users and/or applications and these modules. In an embodiment, the application interface module 312 is configured to interact with any or all other modules within encryption manager 300 to relay user input and queries, receive output execution results and responses. In some embodiments, encryption manager 300 connects with API gateway via any suitable network or combination of networks such as the Internet, etc. and uses any suitable communication protocols such as Wi-Fi, Bluetooth, etc. to connect to external systems required to access to perform certain tasks. Further, the API gateway may transmit service requests received from a client interacting with encryption manager 300.

In the illustrated embodiment, admin interface 320 allows users with administrative privileges to perform various administrative tasks associated with encryption manager 300 as described herein. For example, in some embodiments, admin interface 320 allows a user with administrative privileges to initiate a data collection process or network monitoring process. As another example, in some embodiments, admin interface 320 allows a user with administrative privileges to initiate and monitor the training process performed by model training module 316, including setting desired parameters and/or hyperparameters for the training process.

In an embodiment, admin interface 320 includes a user interface configured to allow a user having sufficient privileges to oversee the operation and management of the encryption process. In an embodiment, admin interface 320 controls access permissions, monitors system performance, and handles any administrative tasks related to the platform. In an embodiment, the admin interface 320 interacts with any or all other modules to promote compliance with the administrative settings. Further, a backend administration system allows users with administrative privileges to perform various administrative tasks associated with the encryption manager module as described herein, such as initiating a data collection and/or correlation process, a neural network training process, defining optimization goals, defining execution parameters/criteria, and any other defined settings discussed herein.

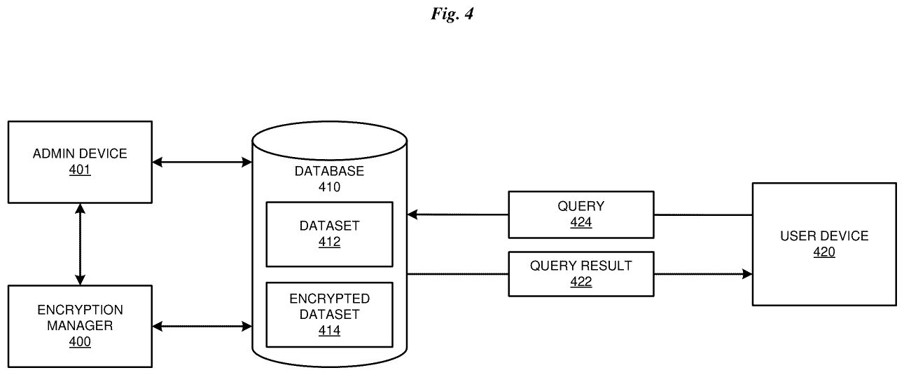

FIG. 4 depicts a block diagram of an example database management system in accordance with an illustrative embodiment. In the illustrated embodiment, the encryption manager 400 includes encryption manager module 200 of FIG. 1 and FIG. 2 and/or encryption manager 300 of FIG. 3. In the illustrated embodiment, a user having sufficient administrative privileges interacts with admin device 401 to initialize encryption manager 400 to perform the example encryption processes described herein.

In the illustrated embodiment, the encryption manager 400 is configured to encrypt the dataset 412 stored on database 410 thereby transforming the dataset 412 into an encrypted dataset 414. In an embodiment, the database 410 includes a vector database storing vector embeddings corresponding to natural language documents. In an embodiment, the encryption manager 400 applies an isomorphic transformation to the vector embeddings stored on the vector database to convert the dataset 412 into a different representation while preserving the geometric structure and distances between data points.

In an embodiment, the encryption manager 400 encrypts a set of embedding vectors corresponding to a set of natural language documents. In an embodiment, the embedding vectors are obtained using a language model. In an embodiment, the encryption manager 400 leverages a distance comparison preserving encryption scheme that enables a cloud server storing the encrypted embedding-vectors to still be able to retrieve the closest embedded-vector to the query embedded-vector, by comparison of the encrypted form. In an embodiment, two documents, paragraphs, sentences, sequences-of-keywords, etc., result in embedding vectors that have a relatively low Euclidean-distance in an n-dimensional real space.

Embodiments of the present disclosure consider an encrypted embedding-vector Esk(v) deciphered if the adversary can obtain a document, paragraph, sentence, sequence-of-keywords, etc. that results in an embedding-vector (under the same language model) that is within Euclidean-distance β of the raw embedding-vector v. Here Esk denotes encryption under a DCPE-encryption scheme with secret-key sk. The distance β is a security-parameter, which is pre-defined based on the language-model and the distribution of the documents. Embodiments consider β should not be so large that a large number of unrelated document/sequence-of-keywords (from the classification-field) are β-close to a particular embedding-vector. Also, for security-definition, β should be allowed to be large enough so that very few unrelated document/sequence-of-keywords (from the classification field) are β-close to a particular embedding-vector.

Embodiments of the present disclosure consider that a secret orthogonal-matrix linear transformation limits an adversary to only trying differential attacks. Accordingly, supposing a DCPE-encryption that perform pre-transform of an orthogonal-matrix linear-transformation, an adversary must first need to take pairwise differences of the given DCPE-encryptions to remove this pre-transform and hence requiring obtaining and analyzing pairs of guesses of documents/keywords. In such case, if each guess is only β-close, then the differential guess may be as far away as 2*β.

Embodiments of the present disclosure consider that an adversary does not know any (or some) of the plaintext documents, apart from insignificant low-entropy information. Moreover, these documents may be high-entropy documents even conditioned on the Adversary knowing that they come from a particular classification field. Embodiments of the present disclosure require the adversary to obtain any plaintext document/sequence-of-keywords P such embedding(P) is within distance β of some v that are encrypted in the encrypted database 410.

Embodiments of the present disclosure consider that the actual document D is encrypted by a semantic-secure scheme, so it is the leakage of information from the embedding-vector embed(D) of the document D that is of concern. In the worst case, it could be stored in the clear in the cloud so as to assist fast search (which is accomplished using k-nearest neighbor algorithms). Let D={Dᵢ}_{i∈[m]} be the set of documents in the database, and let V={embed(Dᵢ)}_{i∈[m]} be the corresponding set of embedding vectors. Dist(w, V) denotes the distance between embed(w) and the nearest document in D. For a sequence-of-keywords w, let the k-nearest to embed(w) in V be denoted by nearₖ(w). Alternatively, one can also define near_{ϵ,V} (w), which includes all vectors in V that are within distance (1+ϵ)-multiple of the nearest element to w. More precisely: near_{ϵ}(w)=near_{ϵ,V} (w)={u∈V|dist(u, V)≤(1+ϵ)dist(near_{1,V} (w), V)}.

Embodiments consider a query to be a focused query focused in V, if dist(w, V) is much smaller than distance to any other near vector in V\nearₖ(w). In other words, the k vectors that were found near embed(w) are indeed the focus group of w, and anything else in V is far away. Embodiments allow k to be more than one, as there maybe a cluster of documents near w. For each w∈V, define k-cluster of w, Cₖ(w)=nearₖ(w), as the subset of documents in V that are k-closest to w in V. The minimum k-separation of w, Δₖ(w) is defined as the minimum distance of V\Cₖ(w) from w. For any k, the almost-minimum k-cluster separation of document set V, Ψₖ(V), is defined as the log|V|-th minimum of Δₖ(w) over all w∈V, i.e. minimum excluding some log|V| anomalous clusters (that have very low separation).

In an embodiment, the encryption manager 400 sets a noise parameter by tuning the level of noise added to the transformed vector database to enhance security and privacy while maintaining the distance-preserving properties of the encryption scheme. In an embodiment, the encryption manager 400 adds noise to the embedding-vectors by appending or pre-pending a fresh random piece of text to each document before passing it through a large-language model transformer to obtain the embedding vectors. In an embodiment, the encryption manager 400 generates the embedding vectors using the large-language model transformer, which encodes the augmented data into high-dimensional vectors capturing semantic and contextual information. In an embodiment, the encryption manager 400 refines the noise parameter by iteratively adjusting the noise level based on clustering techniques applied to the vector database or probability distribution to preserve essential data relationships. In an embodiment, encryption manager 400 encrypts the vector database with the noise-added embedding vectors.

In the illustrated embodiment, the user device 420 may include a computing device accessed by a user or virtual agent to transmit queries to retrieve information from database 410. Accordingly, the user or agent may transmit a query 424 to the database 410 via the user device 420, and in response, the user or agent may receive a query result 422 transmitted back to the user device 420, such that the information contained in query result 422 is based on content and structure of the query 424. Suppose, for example, user device 420 belongs to an attacker performing an incremental query based attack to extract confidential information from database 410. An incremental query attack involves systematically sending queries to a database to infer secret data. Before querying, the undisclosed information has high entropy because it appears highly random and unpredictable to the attacker. By sending queries, the attacker extracts small bits of information, gradually narrowing down the set of possible values, thereby reducing entropy. Once enough queries have been sent, the entropy becomes low because the attacker has a more precise guess of the hidden information.

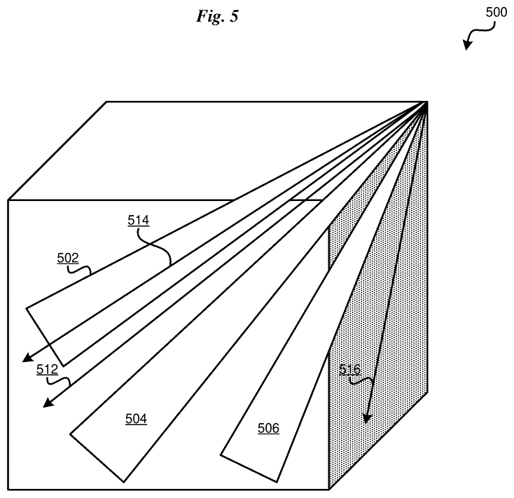

FIG. 5 depicts a block diagram of an example vector embedding space in accordance with an illustrative embodiment. In the embodiment, the vector embedding space 500 includes text data corresponding to various topics and/or sub-topics. In an embodiment, the text data may be clustered according to similarities between vector embeddings representing the stored text data. In the illustrated embodiment, the vector embedding space includes a first cluster 502, a second cluster 504, and a third cluster 506. Accordingly, the vector embedding space 500 organizes and represents text data corresponding to various topics and/or sub-topics in a multi-dimensional space. The text data is encoded as vector embeddings which capture the semantic relationships between different pieces of text.

In the illustrated embodiment, various examples queries are shown which are more or less similar to the clusters shown. In the illustrated embodiment, the queries include a first query 512, a second query 514, and a third query 516. In the illustrated embodiment, the second query 514 is shown closer to the first cluster 502 than the first query 512. Further, in the illustrated embodiment, the third query 516 is shown farthest from the first cluster 502 in comparison to the first query 512 and the second query 514. Further, in the illustrated embodiment, the first query 512 is shown equidistant from the first cluster 502 and the second query 514. Accordingly, the relative positions of the queries to the clusters illustrate how the vector embedding space can be leveraged for information retrieval, topic classification, and semantic similarity assessments. Queries that are closer to a given cluster are more likely to match relevant stored text, whereas queries farther away indicate a weaker semantic relationship.

Suppose an instance where an adversary starts with the third query 516 as initial query and observes its placement within the embedding space 500 relative to known clusters. Based on the observed feedback or data retrieved from the database, the adversary slightly modifies the query in small increments and resubmits a follow-up query, analyzing how the query's position shifts in the vector space. If the adversary reaches the vicinity of a specific cluster, the adversary can infer characteristics of the stored data within that cluster by identifying semantic similarities between successful query modifications. Suppose also that the adversary continues and transmits the first query 512 which is positioned equidistant between the first cluster 502 and the second cluster 504. In this instance, the adversary may be unable to continue an incremental based attack, since when a query is located midway between two clusters, incremental modifications do not provide a clear signal about which direction leads toward a specific target. Unlike a case where the query starts closer to a single cluster and simply moves toward it, here, every further minor adjustment might move the query unpredictably toward either cluster.

In accordance with the above example, perturbations and noise can be strategically introduced to obfuscate the semantic relationships between data points within the vector embedding space 500, causing adversaries to be unable extract meaningful patterns through incremental query attacks. Embodiments of the present disclosure disrupt the adversary's ability to infer the structure of the embedding space while preserving usability for legitimate applications through the application of a distance preserving encryption comprises a customizable noise parameter.

Suppose the different queries are analyzed based on how close their k-nearest neighbors are within the embedding space 500. For example, suppose a query has its nearest neighbors within a bounding distance ϵ, while the next nearest point outside of this group is 4ϵ away. Since this is a large gap, the query is well-focused on its nearest cluster. On the other hand, if a query has its nearest neighbors at a distance of 3ϵ, but the next nearest point is only slightly farther at 3.1ϵ. This means the query is not very well-focused, as it doesn't have a strong separation between nearby and far points. For another query the nearest neighbors are at 15ϵ, with the next nearest point at 18ϵ, meaning that the query is very loosely focused and spread widely in the space.

An embodiment of the present disclosure organizes data in an embedding space 500 while refining which keywords are important for classification. In an embodiment, the process establishes a distance baseline for the document collection V, determining a separation distance Ψₖ(V) between small groups of similar documents. If the separation is too small (less than 0.1×σ×√n), a different noise-handling strategy may be employed to prevent excessive clustering that otherwise may reduce the effectiveness of the embedding space.

In an embodiment, the process includes filtering out unimportant keywords. The algorithm starts with a dictionary of keywords (E) relevant to the document category. Some words, such as numbers, may be ignored, but proper names (e.g., drug names, chemical compounds, etc.) should be retained. A threshold (Δmin=2) determines which keywords are “focused” enough to be kept in the dataset. The remaining important keywords form a refined set E₁, which serves as the foundation for further refinement.

In an embodiment, the process expands the keyword groups, building larger keyword combinations (E₂, E₃, . . . ) by adding important words to the focused set. At each stage, only the most relevant keyword combinations are retained to prevent an exponential explosion in the number of keyword sets. This ensures that the embedding space remains efficient and does not become overly complex.

In an embodiment, to measure how well these queries align with the document set, the average distance (δₜ) between focused keyword queries and V is calculated. If the incremental improvement in distance between iterations falls below 2×Ψₖ(V), the refinement process stops. This prevents excessive fine-tuning when additional keyword modifications no longer yield significant improvements in clustering.

In an embodiment, the privacy parameter (β) for a privacy-preserving search algorithm (DCPE) is determined using the final distance improvement (δₜ₋₁−δₜ). This ensures that queries on the dataset do not reveal too much information, preventing adversaries from reverse-engineering the dataset. Instead of using a simple average distance, the method can customize noise per cluster to further enhance privacy. If the dataset has poor separation (clusters too close together), additional phrases may be included in queries to artificially improve separation and preserve structured searchability. The final dataset allows for useful similarity searches while making it difficult for attackers to extract sensitive underlying patterns.

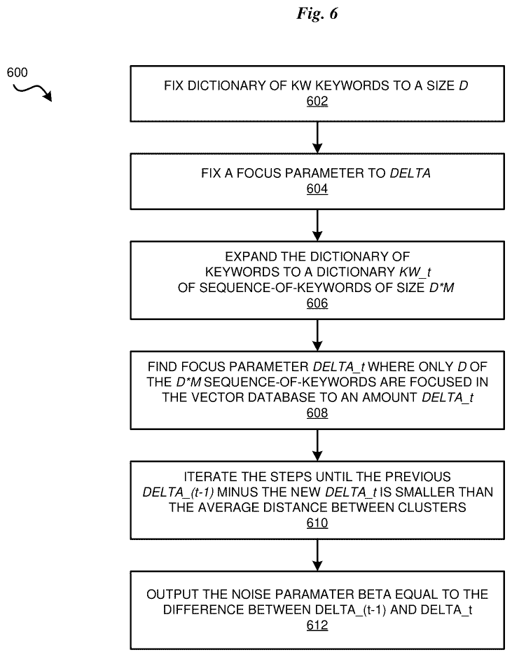

FIG. 6 depicts a flowchart of an example process for setting a noise parameter for distance preserving encryption. In an embodiment, encryption manager module 200 of FIGS. 1 and 2, encryption manager 300 of FIG. 3, and/or encryption manager 400 of FIG. 4, carries out some or all of the steps of process 600.

In an embodiment, at step 602, the process includes fixing a dictionary of KW keywords to a size D. This step establishes the initial dictionary size containing D keywords, which serves as the basis for subsequent operations involving keyword manipulation and focus parameter adjustment.

In an embodiment, at step 604, the process includes fixing a focus parameter to Delta. By setting the focus parameter to a specific value, the process determines the level of attention or emphasis given to certain keywords within the dictionary during the encryption process, thereby influencing the encryption scheme's behavior and the resulting encrypted data. The dictionary KW is initially set to contain D keywords, while the focus parameter Delta determines the level of focus or attention given to specific keywords within the vector database.

In an embodiment, at step 606, the process includes expanding the dictionary of keywords to a dictionary KW_t of sequence-of-keywords of size D*M. This expansion broadens the scope of keywords considered during the encryption process. In an embodiment, in the iterated steps, the keyword dictionary is expanded to a new dictionary KW_t of sequence-of-keywords with a size of D*M, where M is a parameter that influences the expansion factor. Embodiments disclosed herein consider that the dictionary of keywords may be expended in multiple ways. For example, in the instance of a chemical formula, the dictionary of keywords may be expanded by appending radicals or amino acids. In in the instance of plain English text, the dictionary of keywords may be expanded by appending a t-th keyword to a previous (t−1)-sequence of keywords. Accordingly, the exact dictionary of keywords and expanding dictionary of keywords may be implementation specific.

In an embodiment, at step 608, the process includes finding a focus parameter Delta_t where only D of the D*M sequence-of-keywords are focused in the vector database to an amount Delta_t. This step refines the focus parameter to concentrate on a subset of keywords within the expanded dictionary, adjusting the focus level to an optimal amount that aligns with the data characteristics and encryption requirements. In an embodiment, the focus parameter Delta_t is recalibrated to concentrate on a subset of D keywords from the expanded dictionary KW_t, adjusting the focus level to an amount Delta_t. This step refines the focus of the noise parameter tuning process, emphasizing specific keywords for preserving the distance relationships within the vector database.

In an embodiment, at step 610, the process involves iterating the steps until the previous Delta_(t−1) minus the new Delta_t is smaller than the average distance between clusters. This iterative process ensures that the focus parameter is fine-tuned to a level where the differences between successive focus parameters are minimized, enhancing the process's ability to maintain the desired focus on key keywords while optimizing the encryption process. In an embodiment, the iteration continues by iteratively updating the keyword dictionary, expanding the focus parameter, and refining the noise level until a convergence criterion is satisfied. The convergence criterion may be determined by comparing the difference between the previous focus parameter Delta_(t−1) and the new focus parameter Delta_t to the average distance between clusters in the data.

In an embodiment, the iteration stops when the difference falls below the average distance between clusters, indicating that the noise parameter has been tuned to a level that preserves the essential data relationships within the vector database. By following this iterative process of expanding the keyword dictionary, adjusting the focus parameter, and iteratively refining the noise level based on the convergence criterion, the tuning of the noise parameter can be systematically optimized to enhance the effectiveness of distance-preserving encryption while maintaining the integrity and structure of the data. In an embodiment, at step 612, the process outputs a noise parameter beta equal to the difference between Delta_(t−1) and Delta_t.

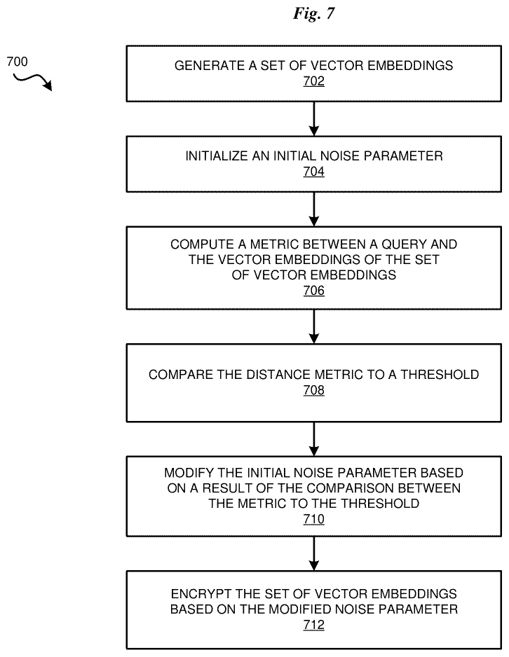

FIG. 7 depicts a flowchart of an example process 700 for setting a noise parameter for a distance preserving encryption technique. In an embodiment, encryption manager module 200 of FIGS. 1 and 2, encryption manager 300 of FIG. 3, and/or encryption manager 400 of FIG. 4 carries out some or all of the steps of process 700.

In an embodiment, at step 702, the process includes generating a set of vector embeddings. This initial step involves transforming textual data into digital vector representations using techniques such as word embeddings or document embeddings. The vector embeddings capture the semantic meaning and contextual information of the text, providing a digital representation of the data that can be further processed.

In an embodiment, at step 704, the process includes initializing an initial noise parameter. The noise parameter is a variable that controls the level of randomness or perturbations added to the vector embeddings during the encryption process. In an embodiment, initializing the noise parameter is accomplished by executing a first specifically purposed code within a noise generating module of an encryption manager application. In an embodiment, the first specifically purposed code selects a first amount of text data to append to a portion of the natural language documents.

In an embodiment, at step 706, the process includes computing a distance metric between a query and the vector embeddings of the set of vector embeddings. Accordingly, the process computes a distance metric between a query embedding and the embeddings in the database. The distance metric quantifies the similarity or dissimilarity between the query vector and the vector embeddings, providing a measure of the relationship between the query and the vector embedding data. Further, this metric measures how close or far the embeddings are from the query, reflecting the effectiveness of searchability.

In an embodiment, at step 708, the process includes comparing the distance metric to a distance threshold. The distance threshold serves as a reference point to determine the proximity between the query and the vector embeddings. By comparing the distance metric to the threshold, the system evaluates whether the query is sufficiently close to the data based on the defined threshold.

In an embodiment, at step 710, the process includes modifying the initial noise parameter based on the result of the comparison between the distance metric and the threshold. The modification of the noise parameter is informed by the comparison outcome, adjusting the level of noise added to the vector embeddings to optimize the security and privacy of the encryption scheme. In an embodiment, adjusting the noise parameter is accomplished iteratively executing a second specifically purposed code within the noise generating module. In an embodiment, the second specifically purposed code increases the amount of appended text data in response to the comparisons, and outputs an adjusted noise parameter for each iteration.

In an embodiment, at step 712, the process includes encrypting the set of vector embeddings based on the modified noise parameter. The vector embeddings are encrypted using the updated noise parameter to enhance the security of the data while preserving the inherent relationships and distances between the vector representations. By continuously refining the noise level based on the distance metric, the process optimizes privacy protection while maintaining search efficiency in the encrypted domain.

In an embodiment, the vector embeddings are transformed into encrypted representations using a cryptographic algorithm and key to protect the confidentiality and integrity of the data. In an embodiment, the vector embeddings are encrypted using a distance-comparison-preserving encryption (DCPE) scheme. This encryption ensures that the relationships between embeddings (such as proximity in vector space) remain intact, allowing secure nearest-neighbor searches on encrypted data. In an embodiment, the encrypting of the vector embeddings is accomplished by executing specifically purposed code within the encryption module of the encryption manager application. In an embodiment, the specifically purposed code uses a distance-preserving encryption function to encrypt the final set of modified vector embeddings, wherein the final set of vector embeddings comprises a set of vector embeddings generated immediately prior to a determination that no further benefit is provided by appending additional text data.

Embodiments of the present disclosure mention measuring a distance metric and comparing the distance metric to a predefined distance threshold. However, the use of this example is not intended to be limiting, but rather illustrates a particular embodiment of the present disclosure. In some other embodiments, the measurement metric and/or predefined threshold may include, but is not limited to, distance between vectors, a number such as size of a cluster, or a size determined by downstream applications such as k-nearest neighbor search.

Embodiments of the present disclosure may include generating and applying different noise levels to different vector embeddings based on their proximity to cluster boundaries within an embedding space. In an embodiment, the process may include generating a set of vector embeddings from natural language documents, images, or other input data using a machine learning model. These embeddings are then analyzed to identify clusters—groups of embeddings that share similar semantic or statistical characteristics—using a clustering algorithm such as k-means, DBSCAN, or hierarchical clustering. Once clusters are established, the proximity of each embedding to its nearest cluster boundary is computed. This may involve calculating the distance between the embedding and either the centroid of the cluster it belongs to or to the closest point along a separating hyperplane or decision boundary between clusters. The final encrypted representation of each embedding is thus influenced by a context-sensitive noise parameter, which is adaptively tuned based on local embedding space topology.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
comparing to a threshold a first dataset characteristic of a set of embedding vectors generated from a set of natural language documents, the comparing producing a first comparison result;
appending to output a first set of augmented documents, by executing a first specifically purposed code within a noise generating module of an encryption manager application, a first amount of text data to a first portion of a natural language document from the set of natural language documents according to a noise parameter based on the first comparison result;
generating, by processing the first set of augmented documents through a large language model, a first set of modified vector embeddings representing the first set of augmented documents;
adjusting, by iteratively executing a second specifically purposed code within the noise generating module, the noise parameter based on successive comparisons between an updated dataset characteristic and the threshold, wherein in an iteration the second specifically purposed code changes the first amount of text data according to a comparison in the successive comparisons, and outputs an adjusted noise parameter for the iteration;
augmenting the first portion of the natural language documents by appending a changed amount text data in accordance with the adjusted noise parameter to generate a changed set of augmented documents;
outputting, by executing a third specifically purposed code within the noise module of the encryption manager application, a final set of modified vector embeddings corresponding to the set of natural language documents, the final set of modified vector embeddings being usable to tune a distance preserving setting in an encryption operation.

2. The computer-implemented method of claim 1, further comprising:
encrypting, by executing a fourth specifically purposed code within an encryption module of the encryption manager application, and by using the distance preserving setting in a distance preserving scheme technique, the final set of modified vector embeddings.

3. The computer-implemented method of claim 2, wherein the encrypting uses a distance-preserving encryption function, wherein the final set of modified vector embeddings is responsive to an n-th comparison in an n-th iteration indicating a less than a preset amount of benefit by further changing a previous amount of text data from an (n−1)th iteration.

4. The computer-implemented method of claim 1, further comprising:
measuring, within a measurement module of the encryption manager application, the first dataset characteristic from a set of embedding vectors generated from the set of natural language documents.

5. The computer-implemented method of claim 1, further comprising:
initializing the noise parameter based on the first comparison result, wherein the first amount of text data is selected based on the first comparison result.

6. The computer-implemented method of claim 1, further comprising:
generating, during the iteratively executing the second specifically purposed code, successive sets of modified vector embeddings from successive sets of augmented documents by processing each iteratively augmented documents through the large language model, a modified vector embedding in the successive sets of modified vector embeddings representing a corresponding augmented document.

7. The computer-implemented method of claim 1, wherein the adjusting, the augmenting, and the generating are repeated until an n-th comparison in an n-th iteration indicating a less than a preset amount of benefit by further changing a previous amount of text data from an (n−1)th iteration.

8. The computer-implemented method of claim 1, wherein a changed amount text data is an additional amount of text data.

9. The computer-implemented method of claim 1, wherein measuring the first dataset characteristic comprises computing pairwise distances between vector embeddings.

10. The computer-implemented method of claim 9, wherein the computing pairwise distances comprises computing k-nearest neighbor between clusters of vectors of the vector embeddings and a query vector embedding.

11. The computer-implemented method of claim 1, wherein measuring the first dataset characteristic comprises measuring a probability distribution of the set of embedding vectors.

12. The computer-implemented method of claim 11, wherein initializing noise is based on the probability distribution of the set of embedding vectors.

13. The computer-implemented method of claim 1, wherein the threshold comprises at least one of a distance, a size of a cluster, or a metric determined by k-nearest neighbor search.

14. The computer-implemented method of claim 1, wherein a threshold module dynamically adjusts the threshold based on real-time variations in a distribution of vector embeddings.

15. The computer-implemented method of claim 1, wherein the encryption module applies different noise levels to different vector embeddings based on their proximity to cluster boundaries within an embedding space.

16. A computer program product comprising one or more computer readable storage media, and program instructions collectively stored on the one or more computer readable storage media, the program instructions executable by a processor to cause the processor to perform operations comprising:
comparing to a threshold a first dataset characteristic of a set of embedding vectors generated from a set of natural language documents, the comparing producing a first comparison result;
appending to output a first set of augmented documents, by executing a first specifically purposed code within a noise generating module of an encryption manager application, a first amount of text data to a first portion of a natural language document from the set of natural language documents according to a noise parameter based on the first comparison result;
generating, by processing the first set of augmented documents through a large language model, a first set of modified vector embeddings representing the first set of augmented documents;
adjusting, by iteratively executing a second specifically purposed code within the noise generating module, the noise parameter based on successive comparisons between an updated dataset characteristic and the threshold, wherein in an iteration the second specifically purposed code changes the first amount of text data according to a comparison in the successive comparisons, and outputs an adjusted noise parameter for the iteration;
augmenting the first portion of the natural language documents by appending a changed amount text data in accordance with the adjusted noise parameter to generate a changed set of augmented documents;
outputting, by executing a third specifically purposed code within the noise module of the encryption manager application, a final set of modified vector embeddings corresponding to the set of natural language documents, the final set of modified vector embeddings being usable to tune a distance preserving setting in an encryption operation.

17. The computer program product of claim 16, wherein the program instructions are stored in a computer readable storage device in a data processing system, and wherein the stored program instructions are transferred over a network from a remote data processing system.

18. The computer program product of claim 16, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

19. The computer program product of claim 16, wherein the threshold module dynamically adjusts the threshold based on real-time variations in a distribution of vector embeddings.

20. A computer system comprising a processor and one or more computer readable storage media, and program instructions collectively stored on the one or more computer readable storage media, the program instructions executable by the processor to cause the processor to perform operations comprising:
comparing to a threshold a first dataset characteristic of a set of embedding vectors generated from a set of natural language documents, the comparing producing a first comparison result;
appending to output a first set of augmented documents, by executing a first specifically purposed code within a noise generating module of an encryption manager application, a first amount of text data to a first portion of a natural language document from the set of natural language documents according to a noise parameter based on the first comparison result;
generating, by processing the first set of augmented documents through a large language model, a first set of modified vector embeddings representing the first set of augmented documents;
adjusting, by iteratively executing a second specifically purposed code within the noise generating module, the noise parameter based on successive comparisons between an updated dataset characteristic and the threshold, wherein in an iteration the second specifically purposed code changes the first amount of text data according to a comparison in the successive comparisons, and outputs an adjusted noise parameter for the iteration;
augmenting the first portion of the natural language documents by appending a changed amount text data in accordance with the adjusted noise parameter to generate a changed set of augmented documents;
outputting, by executing a third specifically purposed code within the noise module of the encryption manager application, a final set of modified vector embeddings corresponding to the set of natural language documents, the final set of modified vector embeddings being usable to tune a distance preserving setting in an encryption operation.
